(19) United States
(12) Patent Application Publication
(10) Pub. No.: US 2021/0018892 A1
(43) Pub. Date: Jan. 21, 2021

(54) POSITION ADJUSTMENT DEVICE AND ULTRAPRECISION MACHINE TOOL

(71) Applicant: FANUC CORPORATION, Minamitsuru-gun (JP)

(72) Inventor: Toyoaki SUZUKI, Yamanashi-ken (JP)

(21) Appl. No.: 16/926,629

(22) Filed: Jul. 10, 2020

(30) Foreign Application Priority Data
Jul. 17, 2019 (JP) 2019-131740

(51) Int. Cl. G05B 19/402; G05B 19/18; G05B 19/408

(52) U.S. Cl. CPC G05B 19/402; G05B 19/4083; G05B 19/182

(57) ABSTRACT

A position adjustment device for adjusting a height of an object to be supported includes: a fixed portion; a movable portion provided to be movable in the height direction relative to the fixed portion and supporting the object to be supported; an expanding and contracting portion coupled to the fixed portion and the movable portion and having formed therein a plurality of cuts extending along a first direction that is orthogonal to the height direction; and an adjustment mechanism configured to adjust expansion and contraction of the expanding and contracting portion. The expanding and contracting portion has a crank shape in which a plurality of the cuts formed on one side in the first direction and a plurality of the cuts formed on the other side in the first direction are alternated along the height direction.

### CROSS-REFERENCE TO RELATED APPLICATION

This application is based upon and claims the benefit of priority from Japanese Patent Application No. 2019-131740 filed on Jul. 17, 2019, the contents of which are incorporated herein by reference.

### BACKGROUND OF THE INVENTION

### Field of the Invention

The present invention relates to a position adjustment device for adjusting at least the height of the position of an object to be supported and to an ultraprecision machine tool.

### Description of the Related Art

Japanese Utility Model Registration No. 3112302 discloses a jig including a lower half 16 to be placed on a worktable, an upper half 15 for supporting an object to be cut, which is an object to be supported, and an arc-shaped connection 17 connecting the lower half 16 and the upper half 15. The jig disclosed is capable of adjusting the position of the object supported on the upper half 15 by adjusting the position of the upper half 15 relative to the lower half 16 with the upper half 15 kept connected to the arc-shaped connection 17.

### SUMMARY OF THE INVENTION

When adjusting the height of an object to be supported using a position adjustment device, it is undesirable if the object to be supported is displaced in directions other than the height direction. With the jig disclosed in Japanese Utility Model Registration No. 3112302, it is difficult to adjust the position only along the height direction while preventing positional displacement in the horizontal direction, since the jig adjusts the position by opening the L-shaped groove 14 between the lower half 16 and the upper half 15 using the arc-shaped connection 17 as the fulcrum.

Accordingly, an object of the present invention is to provide a position adjustment device and an ultraprecision machine tool with a reduced possibility of positional displacement in unintended directions.

An aspect of the present invention provides a position adjustment device for adjusting a height of an object to be supported. The position adjustment device includes: a fixed portion; a movable portion provided to be movable in the height direction relative to the fixed portion and configured to support the object to be supported; an expanding and contracting portion coupled to the fixed portion and the movable portion and having formed therein a plurality of cuts extending along a first direction that is orthogonal to the height direction; and an adjustment mechanism configured to adjust expansion and contraction of the expanding and contracting portion. The expanding and contracting portion has a crank shape in which a plurality of the cuts formed on one side in the first direction and a plurality of the cuts formed on the other side in the first direction are alternated along the height direction.

According to another aspect of the present invention, an ultraprecision machine tool configured to machine a workpiece according to a command for performing machining of 100 nm or less includes the position adjustment device of the aspect recited above.

The present invention thus provides a position adjustment device and an ultraprecision machine tool capable of reducing the possibility of positional displacement in unintended directions.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram illustrating the configuration of an ultraprecision machine tool according to an embodiment;

FIG. 2 is a perspective view of a position adjustment device of the embodiment;

FIG. 3 is a side view of an expanding and contracting portion of the embodiment;

FIG. 4 is a side view of the position adjustment device of the embodiment, where the expanding and contracting portion is not expanded;

FIG. 5 is a side view of the position adjustment device of the embodiment, where the expanding and contracting portion is expanded;

FIG. 6 is a side view of a position adjustment device according to a first modification; and

FIG. 7 is a perspective view of a position adjustment device according to a second modification.

### DESCRIPTION OF THE PREFERRED EMBODIMENTS

The position adjustment device and ultraprecision machine tool according to the present invention will now be described in detail below in connection with preferred embodiments while referring to the accompanying drawings. The directions in the description below follow the arrows in the drawings.

### Embodiment

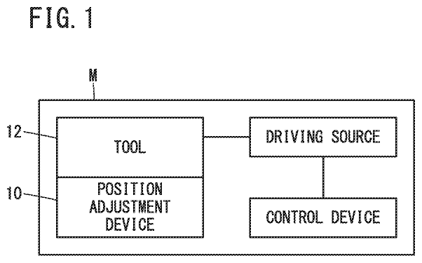

FIG. 1 is a block diagram illustrating the configuration of an ultraprecision machine tool M of this embodiment.

The ultraprecision machine tool M is a machine tool configured to machine a workpiece according to commands for performing machining of 100 nm (nanometers) or less. The ultraprecision machine tool M includes a position adjustment device 10 and a tool (object to be supported) 12 that is supported by the position adjustment device 10.

The ultraprecision machine tool M may further include a driving source (e.g., a motor) for driving the tool 12, a control device for controlling the driving source, and so on. However, this embodiment assumes that the constituent components of the ultraprecision machine tool M other than the position adjustment device 10 can be suitably constructed according to known techniques, and such components will not be described in detail herein.

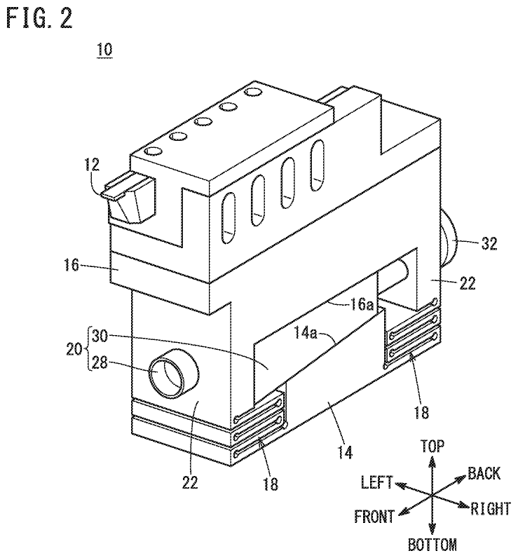

FIG. 2 is a perspective view of the position adjustment device 10 of this embodiment.

The position adjustment device 10 is a device that is configured to adjust the position of the object to be supported, 12, in at least a height direction (top-bottom direction, up-down direction). The position adjustment device 10 allows the operator to easily keep the object to be supported 12 at a desired height. As mentioned above, the object to be supported 12 in this embodiment is the tool 12 of the ultraprecision machine tool M.

The position adjustment device 10 includes a fixed portion 14, a movable portion 16 provided to be movable in the height direction relative to the fixed portion 14 and supporting the tool 12, expanding and contracting portions 18 coupled to the fixed portion 14 and the movable portion 16, and an adjustment mechanism 20 for adjusting expansion and contraction of the expanding and contracting portions 18. These components will be described sequentially below.

The fixed portion 14 is made of an alloy material, for example. The fixed portion 14 has an inclined surface 14a that is formed on a side thereof facing toward the movable portion 16 (on the upper side) and inclined along the front-back direction that is orthogonal to the height direction.

The inclined surface 14a of this embodiment (FIG. 2) is inclined upward from the front side to back side. However, note that the configuration of FIG. 2 is shown only by way of example. The inclined surface 14a may be inclined downward from the front side to back side.

The movable portion 16 is made of the same alloy material as the fixed portion 14, for example. The movable portion 16 includes a lower surface 16a formed on a side thereof facing toward the fixed portion 14, and legs 22 provided respectively at both ends of the lower surface 16a in the front-back direction. The lower surface 16a is a flat plane that is orthogonal to the height direction and faces the inclined surface 14a of the fixed portion 14, with the adjustment mechanism 20 interposed therebetween. The legs 22 extend along the direction toward the fixed portion 14 (downwardly).

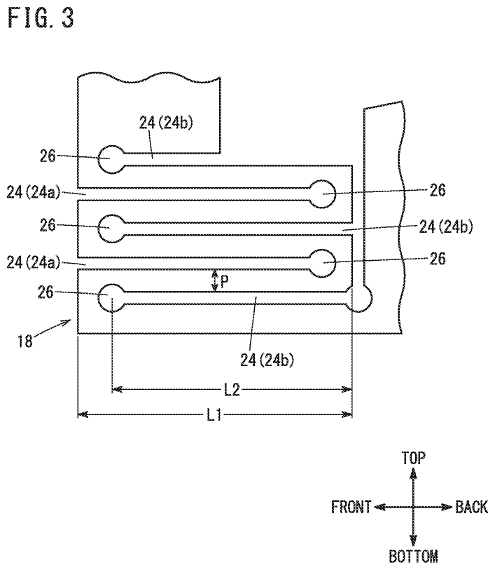

FIG. 3 is a side view of an expanding and contracting portion 18 of the embodiment. FIG. 3 shows the expanding and contracting portion 18 that is disposed on the front side of the fixed portion 14 in FIG. 2, as viewed from the right side.

The expanding and contracting portions 18 are made of the same alloy material as the fixed portion 14 and the movable portion 16 in this embodiment. While the number of expanding and contracting portions 18 is not limited, this embodiment includes “two” expanding and contracting portions 18. The two expanding and contracting portions 18 are provided adjacent respectively to both sides of the fixed portion 14 in the front-back direction.

Each expanding and contracting portion 18 has a plurality of cuts 24 extending along a direction (first direction) that is orthogonal to the height direction. Now, in this embodiment, directions orthogonal to the height direction include the “front-back direction (the direction in which the expanding and contracting portions 18 and the fixed portion 14 adjoin each other, i.e., the adjoining direction)” and the “left-right direction (the direction orthogonal to the direction in which they adjoin each other)”. This embodiment will be described assuming that the “front-back direction” is the “first direction”.

The plurality of cuts 24 formed in the expanding and contracting portion 18 are classified into first cuts 24a made on one side (front side) in the first direction and second cuts 24b made on the other side (back side) in the first direction.

The first cuts 24a and the second cuts 24b are arranged and alternated along the height direction in the expanding and contracting portion 18. A length L2 of each of the plurality of cuts 24 is less than a length L1 of the expanding and contracting portion 18 in the first direction, and equal to or longer than half the length L1 of the expanding and contracting portion 18 in the first direction. Thus, each expanding and contracting portion 18 has a crank shape that can expand and contract in the height direction.

The expanding and contracting portions 18 described above, having the plurality of cuts 24 formed along the first direction (front-back direction), can deform easily along the height direction, but are not likely to deform along the left-right direction.

In this embodiment, a curved portion 26, whose cross section along the first direction is shaped substantially circular, is provided at the end of each of the plurality of cuts 24. The formation of curved portions 26 allows the expanding and contracting portions 18 to deform more easily along the height direction. Furthermore, it is possible to easily adjust the elasticity of the expanding and contracting portions 18 by appropriately changing the size of the curved portions 26 at the design stage.

In this embodiment, the maximum amount of expansion/contraction of the expanding and contracting portions 18 in the height direction can be appropriately changed by appropriately changing the number of cuts 24 formed in the expanding and contracting portions 18 at the design stage.

Further, in this embodiment, the rigidity of the expanding and contracting portions 18 can be changed by appropriately changing a pitch p at the design stage. The term “pitch p” here means the distance between a first cut 24a and a second cut 24b that are adjacent to each other in the height direction.

The length L2 of the cuts 24 may be appropriately changed at the design stage. As the length L2 of the cuts 24 increases, the expanding and contracting portions 18 expand and contract more easily in the height directions. As the length L2 of the cuts 24 shortens, the expanding and contracting portions 18 have higher rigidity. In this way, the rigidity of the expanding and contracting portions 18 can be varied also by appropriately changing the length L2 of the cuts 24, as well as the pitch p.

The length L2 of each of the plurality of cuts 24 need not necessarily be equal among all cuts 24. For example, as shown in FIG. 3, the cut 24 that is closest to the movable portion 16 (on the uppermost side) may be shorter along the front-back direction than other cuts 24.

In this embodiment, the structures of the two expanding and contracting portions 18 disposed on the front and back sides of the fixed portion 14 are symmetrical with each other in the front-back direction. This provides the two expanding and contracting portions 18 with a substantially equal degree of rigidity and allows the two expanding and contracting portions 18 to expand and contract a substantially equal amount in the height directions.

Each of the two expanding and contracting portions 18 has its one end integrally coupled (connected) to the fixed portion 14 and the other end integrally coupled (connected) to the leg 22 of the movable portion 16. The configuration in which the expanding and contracting portion 18 is connected (i.e., coupled integrally) to the movable portion 16 and the fixed portion 14 offers superior rigidity to, and is hence more desirable than, configurations in which the expanding and contracting portions 18 are coupled to the movable portion 16 and the fixed portion 14 through some coupling member. The structure in which the expanding and contracting portion 18 is integrally connected to the fixed portion 14 and the movable portion 16 is not particularly limited, but can be easily obtained by machining one alloy material with a machine tool, for example.

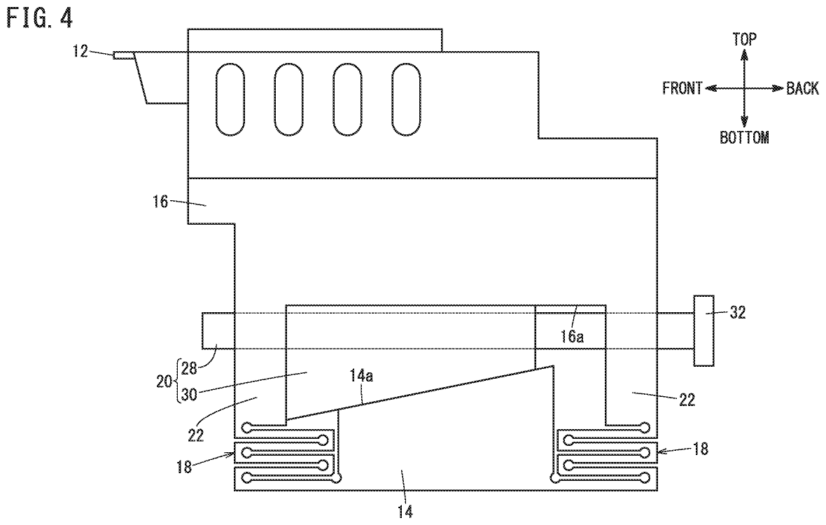

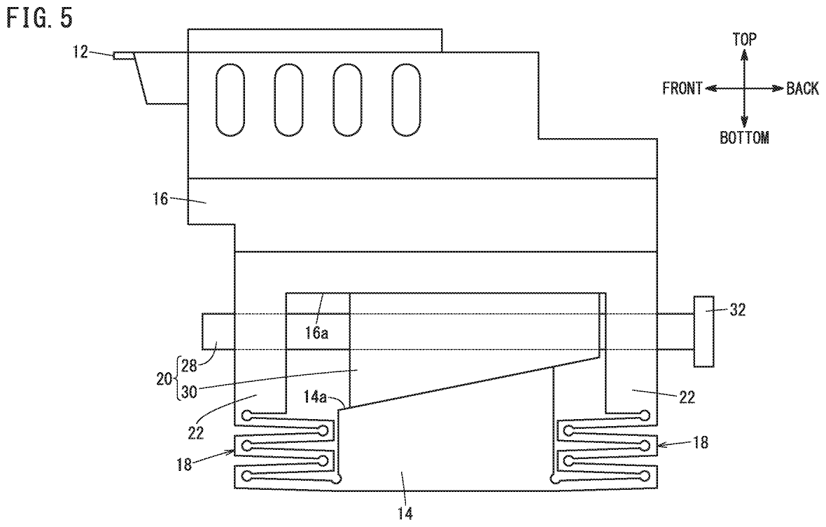

FIG. 4 is a side view of the position adjustment device 10 of this embodiment, where the expanding and contracting portions 18 are not expanded. FIG. 5 is a side view of the position adjustment device 10 of this embodiment, where the expanding and contracting portions 18 are expanded. FIGS. 4 and 5 show the position adjustment device 10 as viewed from the right side.

The adjustment mechanism 20 is positioned between the fixed portion 14 and the movable portion 16 in this embodiment. The adjustment mechanism 20 includes a deflector-type ball screw (operated portion) 28 passing (penetrating) through the two legs 22 along the front-back direction, and a slide member 30 coupled to the ball screw 28 in such a manner that the slide member 30 can slide along the front-back directions as the ball screw 28 turns. In this embodiment, a handle (grip portion) 32 that can turn integrally with the ball screw 28 is provided at one end of the ball screw 28 in the front-back direction. The operator can easily turn the ball screw 28 by holding and turning the handle 32.

The slide member 30 is a wedge-shaped member that is in contact, in the height direction, with the lower surface 16a of the movable portion 16 and with the inclined surface 14a of the fixed portion 14, and the slide member 30 slides within the range between the two legs 22. The operator can easily adjust the height of the movable portion 16, and hence the height of the tool 12 supported on the movable portion 16, by operating (turning) the ball screw 28.

For example, suppose that the operator turns the ball screw 28 so as to slide the slide member 30 from the front side to back side. Then, while moving backward, the slide member 30 gradually moves also upward along the inclined surface 14a of the fixed portion 14. In addition, as shown in FIG. 5, the expanding and contracting portions 18 coupled to the fixed portion 14 and the movable portion 16 expand in the height direction. The movable portion 16 is moved upward by being lifted by the slide member 30 gradually moving upward. On the other hand, when the slide member 30 is moved from the back side to front side, the movable portion 16 moves downward as the slide member 30 moves gradually downward while moving frontward. The expanding and contracting portions 18 at this time contract in the height direction.

In this embodiment, as mentioned above, the expanding and contracting portions 18 are not likely to deform along the left-right directions. Consequently, according to the position adjustment device 10 of this embodiment, the position of the tool 12 can be easily adjusted in the height direction, while preventing positional displacement of the movable portion 16 and the tool (object to be supported) 12 in unintended, left-right directions. Furthermore, preventing positional displacement of the tool 12 in unintended directions reduces the possibility of deterioration of machining accuracy of the ultraprecision machine tool M which would be caused by the positional displacement of the tool 12.

This embodiment is not limited to the configurations shown above. For example, while the first direction has been described as the front-back direction, the first direction may be the left-right direction. That is, each expanding and contracting portion 18 may have a plurality of first cuts 24a formed on one side of the left-right direction and a plurality of second cuts 24b formed on the other side of the left-right direction. This configuration of the position adjustment device 10 reduces the possibility of positional displacement of the movable portion 16 and the tool 12 in the unintended, front-back directions.

The description above has mentioned that connecting the expanding and contracting portions 18 integrally to the fixed portion 14 and the movable portion 16 is desirable from the perspective of rigidity, but this embodiment is not limited thereto. For example, the expanding and contracting portions 18 may be coupled to the fixed portion 14 and the movable portion 16 by screws or bolts.

The description above has mentioned that the materials of the fixed portion 14, the movable portion 16, and the expanding and contracting portions 18 contain the same alloy material, but the embodiment is not limited thereto. For example, the material of the fixed portion 14 and the material of the expanding and contracting portions 18 may differ from each other.

The description above has mentioned that the operated portion 28 is a deflector-type ball screw 28, but the embodiment is not limited thereto. The operated portion 28 need not necessarily include the ball screw 28, as long as it has the function of sliding the slide member 30 in the front-back directions and the function of fixing the slide member 30 after sliding.

The description above has mentioned that the ultraprecision machine tool M operating according to commands for performing machining with a machining accuracy of 100 nm or less includes the position adjustment device 10, but the embodiment is not limited thereto. A machine tool operating according to commands for performing machining with a machining accuracy of 101 nm or more may include the position adjustment device 10.

The description above has illustrated the object to be supported 12 as a tool, but the embodiment is not limited thereto. For example, the object to be supported 12 may be a workpiece that the ultraprecision machine tool M machines.

### [Modifications]

The embodiment has been described as an example of the present invention and the embodiment can of course be modified or improved in various manners. It is clear from the recitation of claims that such modified or improved embodiments are also included in the technical scope of the invention.

### (First Modification)

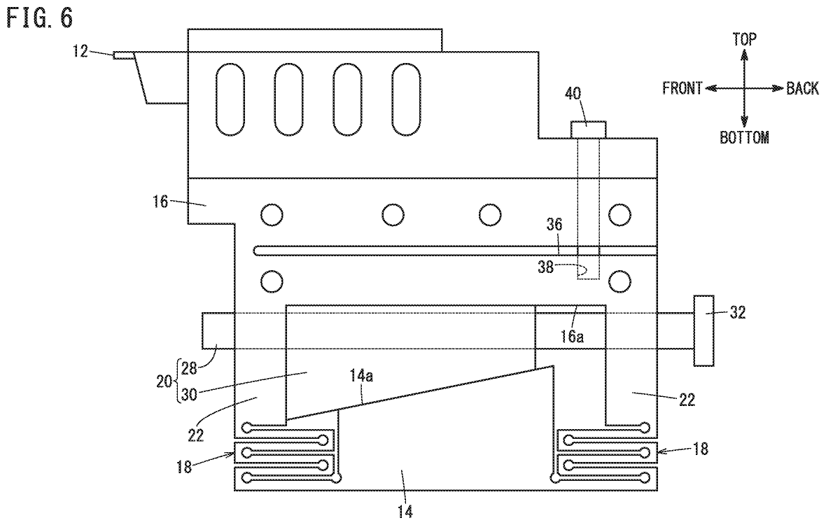

FIG. 6 is a side view of a position adjustment device 10 according to a first modification. FIG. 6 shows the position adjustment device 10 viewed from the right side.

The movable portion 16 may further include an inclination adjustment mechanism 36 for adjusting an inclination of the object to be supported 12 that is supported. This allows the operator to adjust not only the height of the tool 12 but also an inclination of the tool 12.

The inclination adjustment mechanism 36 of this modification is a groove (hereinafter referred to as groove 36) that is formed in the movable portion 16 at a position below the tool 12 in the height direction. In this modification, as shown in FIG. 6, the upper part and lower part of the movable portion 16 that are sectioned by the groove 36 are connected to each other only at the front end of the movable portion 16.

The operator can easily adjust the inclination of the tool 12 by adjusting the inclination of part of the movable portion 16 that is located above the groove 36, with the front end of the movable portion 16 serving as the axis. The movable portion 16 further has formed therein a hole 38 communicating with the groove 36 in the height direction. A fastening member 40 is inserted and fastened in the hole 38 to thereby maintain the inclination adjusted state. The fastening member 40 can be, but is not limited to, a screw, bolt, or pin, for example.

Though the inclination adjustment mechanism 36 illustrated above adjusts the inclination in the front-back direction, this modification can be further modified to adjust the inclination in the left-right direction.

### (Second Modification)

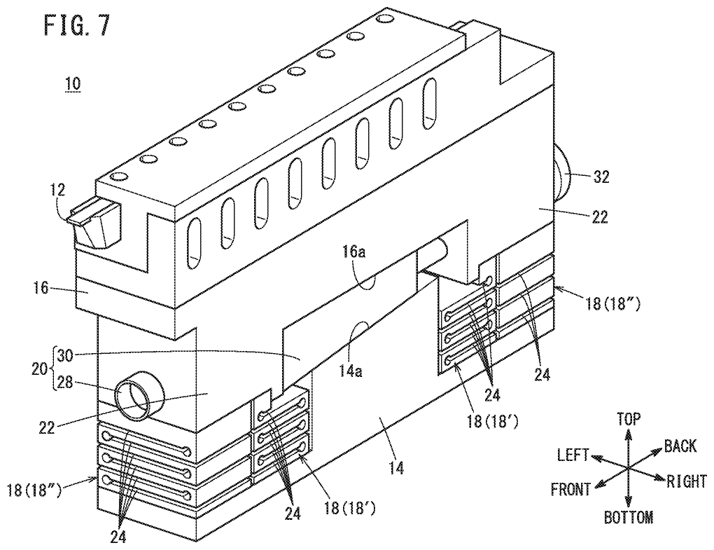

FIG. 7 is a perspective view of a position adjustment device 10 according to a second modification.

The embodiment has shown that the position adjustment device 10 may include a plurality of expanding and contracting portions 18 and that the direction of deformation of the expanding and contracting portions 18 can be restricted by the direction of the cuts 24. Concerning this, two adjacent expanding and contracting portions 18 may be provided on each of one side and the other side of the fixed portion 14. In this case, the first direction in one expanding and contracting portion 18 and the first direction in the other expanding and contracting portion 18 may be orthogonal to each other.

For example, FIG. 7 shows an exemplary configuration of the position adjustment device 10 of this modification. In FIG. 7, two expanding and contracting portions 18 that are adjacent in the front-back direction are provided on each side of the fixed portion 14 in the front-back direction.

Of the two expanding and contracting portions 18 that are adjacent on the front side of the fixed portion 14, one expanding and contracting portion 18 (expanding and contracting portion 18′) has a plurality of cuts 24 whose first direction is the front-back direction. In contrast, the other expanding and contracting portion 18 (expanding and contracting portion 18″) has a plurality of cuts 24 whose first direction is the left-right direction.

Thus, the expanding and contracting portion 18′ prevents positional displacement of the movable portion 16 in the left-right directions, and the expanding and contracting portion 18″ prevents positional displacement of the movable portion 16 in the front-back directions. The same is true with the two expanding and contracting portions 18 (expanding and contracting portion 18′, expanding and contracting portion 18″) that are adjacent on the back side of the fixed portion 14.

In this way, this modification more reliably prevents positional displacement of the object to be supported (tool 12) in unintended directions.

### (Third Modification)

The embodiment has mentioned that the fixed portion 14, the movable portion 16, and the expanding and contracting portions 18 are made of alloy material. The fixed portion 14, the movable portion 16, and the expanding and contracting portions 18 may be made of a damping alloy, for example. The term “damping alloy” means alloys having high vibration damping properties, and manganese-based “M2052 alloy” is known, for example.

The position adjustment device 10 can then offer an improved damping property. Accordingly, even if the supported tool 12 vibrates during machining, for example, the position adjustment device 10 can minimize the vibration to thereby reduce the possibility of deterioration of machining accuracy that would be caused by the vibration of the tool 12.

Further, the damping alloy used as material of the fixed portion 14, the movable portion 16, and the expanding and contracting portions 18 may contain iron. Iron is a material that is easily available and has superior rigidity to manganese.

### (Fourth Modification)

The above-described embodiments and modifications can be arbitrarily combined together within a range in which no inconsistences occur therein.

[Invention Obtained from Embodiments]

The invention graspable from the embodiments and modifications described above will be recited below.

### <First Invention>

A position adjustment device (10) for adjusting a height of an object to be supported (12) includes: a fixed portion (14); a movable portion (16) provided to be movable in the height direction relative to the fixed portion (14) and configured to support the object to be supported (12); an expanding and contracting portion (18) coupled to the fixed portion (14) and the movable portion (16) and having formed therein a plurality of cuts (24) extending along a first direction that is orthogonal to the height direction; and an adjustment mechanism (20) configured to adjust expansion and contraction of the expanding and contracting portion (18). The expanding and contracting portion (18) has a crank shape in which a plurality of the cuts (24a) formed on one side in the first direction and a plurality of the cuts (24b) formed on the other side in the first direction are alternated along the height direction.

A position adjustment device (10) with a reduced possibility of positional displacement in unintended directions is thus provided.

The fixed portion (14) and the movable portion (16) may be spaced from each other in the height direction, the adjustment mechanism (20) may be disposed between the movable portion (16) and the fixed portion (14), and the expanding and contracting portion (18) may be provided on a side of the fixed portion (14). With this configuration, a position adjustment device (10) with a reduced possibility of positional displacement in unintended directions is provided.

The first direction may be a direction in which the expanding and contracting portion (18) and the fixed portion (14) adjoin each other, or a direction that is orthogonal to the direction in which the expanding and contracting portion (18) and the fixed portion (14) adjoin each other. This configuration reduces the possibility that the movable portion (16) and the object to be supported (12) might be unintentionally displaced in the adjoining direction or in the direction orthogonal to the adjoining direction.

On each of one side and the other side of the fixed portion (14), the expanding and contracting portion (18) may include two expanding and contracting portions (18) that are adjacent to each other, wherein the first direction of one of the two adjacent expanding and contracting portions (18) and the first direction of the other expanding and contracting portion (18) may be orthogonal to each other. This configuration reduces both of the possibility that the movable portion (16) and the object to be supported (12) might be unintentionally displaced in the first direction of one expanding and contracting portion (18) and the possibility that the movable portion (16) and the object to be supported (12) might be unintentionally displaced in the first direction of the other expanding and contracting portion (18).

The fixed portion (14) may have an inclined surface (14a) formed on a side thereof that faces toward the movable portion (16), and the adjustment mechanism (20) may include a wedge-shaped slide member (30) being in contact with the movable portion (16) and the inclined surface (14a) and an operated portion (28) configured to be operated to thereby cause the slide member (30) to slide along the inclined surface (14a). This configuration allows the operator to easily adjust the height of the movable portion (16) relative to the fixed portion (14) by operating the operated portion (28).

The expanding and contracting portion (18) may be integrally coupled to the fixed portion (14) and the movable portion (16). This structure improves the rigidity of the position adjustment device (10) compared to structures in which the expanding and contracting portion (18), the fixed portion (14), and the movable portion (16) are formed as separate members.

The movable portion (16) may further include an inclination adjustment mechanism (34) configured to adjust an inclination of the object to be supported (12) that is supported. It is thus possible to adjust not only the height of the tool (12) but also an inclination of the tool (12).

### <Second Invention>

An ultraprecision machine tool (M) configured to machine a workpiece according to a command for performing machining of 100 nm or less includes the position adjustment device (10) according to the <First Invention>.

An ultraprecision machine tool (M) with a reduced possibility of positional displacement of the object to be supported (12) in unintended directions is thus provided. The object to be supported (12) is not particularly limited but can be a workpiece of the ultraprecision machine tool (M) or a tool of the ultraprecision machine tool (M), for example. The ultraprecision machine tool (M) can thus perform machining according to commands for performing machining of 100 nm or less, with good machining accuracy.

What is claimed is:

1. A position adjustment device for adjusting a height of an object to be supported, comprising:
a fixed portion;
a movable portion provided to be movable in a height direction relative to the fixed portion and configured to support the object to be supported;
an expanding and contracting portion coupled to the fixed portion and the movable portion and having formed therein a plurality of cuts extending along a first direction that is orthogonal to the height direction; and
an adjustment mechanism configured to adjust expansion and contraction of the expanding and contracting portion;
wherein the expanding and contracting portion has a crank shape in which a plurality of the cuts formed on one side in the first direction and a plurality of the cuts formed on another side in the first direction are alternated along the height direction.

2. The position adjustment device according to claim 1, wherein
the fixed portion and the movable portion are spaced from each other in the height direction,
the adjustment mechanism is disposed between the movable portion and the fixed portion, and
the expanding and contracting portion is provided on a side of the fixed portion.

3. The position adjustment device according to claim 2, wherein the first direction is a direction in which the expanding and contracting portion and the fixed portion adjoin each other, or a direction that is orthogonal to the direction in which the expanding and contracting portion and the fixed portion adjoin each other.

4. The position adjustment device according to claim 2, wherein the expanding and contracting portion comprises, on each of one side and another side of the fixed portion, two expanding and contracting portions that are adjacent to each other, wherein the first direction of one of the two adjacent expanding and contracting portions and the first direction of another expanding and contracting portion are orthogonal to each other.

5. The position adjustment device according to claim 2, wherein
the fixed portion has an inclined surface formed on a side thereof that faces toward the movable portion, and
the adjustment mechanism includes a wedge-shaped slide member being in contact with the movable portion and the inclined surface, and an operated portion configured to operated to thereby cause the slide member to slide along the inclined surface.

6. The position adjustment device according to claim 1, wherein the expanding and contracting portion is integrally coupled to the fixed portion and the movable portion.

7. The position adjustment device according to claim 1, wherein the movable portion further includes an inclination adjustment mechanism configured to adjust an inclination of the object to be supported that is supported.

8. An ultraprecision machine tool configured to machine a workpiece according to a command for performing machining of 100 nm or less, the ultraprecision machine tool comprising the position adjustment device according to claim 1.
